(19) United States
(12) Patent Application Publication
(10) Pub. No.: US 2021/0122616 A1
(43) Pub. Date: Apr. 29, 2021

(54) Smart Lift Device

(71) Applicant: KTM Solutions, Inc., Greer, SC (US)

(72) Inventors: Paul Kumler, Greer, SC (US); James Theodore, Greer, SC (US); Rian Simpson, Greer, SC (US); Jacob McDaris, Greer, SC (US); David Topham, Greer, SC (US)

(21) Appl. No.: 17/082,391

(22) Filed: Oct. 28, 2020

Related U.S. Application Data
(60) Provisional application No. 62/927,312, filed on Oct. 29, 2019.

(51) Int. Cl. B66D 1/46; G05B 23/02

(52) U.S. Cl. CPC B66D 1/46; G05B 2223/06; G05B 23/0283

(57) ABSTRACT

A smart lifting device, a system, and a related and method for evaluating a duty cycle status of a lifting device suspendable from a support for lifting loads are disclosed. The subject matter may include attaching a load to a base member; lifting the base member and the load using the support; monitoring parameters related to the lifting step using at least one sensor and a lift monitor attached to the base member, the at least one sensor detecting at least an instance of lifting; and reporting information related to the determined parameters. The device and system may include base members and lift monitors with sensors and/or communications devices, as well as optional computer interfaces.

### CROSS-REFERENCE TO RELATED APPLICATIONS

The present application is a Non-Provisional Patent Application and claims priority to U.S. Provisional Patent Application Ser. No. 62/927,312, filed Oct. 29, 2019, which is incorporated by reference herein.

### TECHNICAL FIELD

The present disclosure relates generally to devices for lifting loads.

### BACKGROUND

“Below the hook” (BTH) devices are used for attaching a load to hoist. A common BTH device is known as a “lifting beam,” although BTH devices may also include components such as slings, hooks, and rigging hardware. BTH devices are designed in many shapes and sizes to accomplish different types of lifts and include, but are not limited to, lifting beams, spreader bars, “C” hooks, sheet lifters, and beam clamps. BTH lifting devices such as lifting beams are typically constructed of a metal, such as steel or aluminum. Guidelines for the design of BTH devices can be found in ASME BTH-1. Safety standards for BTH devices can be found in ASME B30.20. A BTH lifting device may be marked with an ASME defined service tag that provides loading guidance (e.g., a maximum number of lifts, or maximum lift load limit) and inspection guidance (e.g., timelines for periodic inspection).

Unfortunately, whether accidentally or by users engaging in unsafe practices, such guidance may not always be followed or tracked, and approximations may be improperly substituted. For example, the safe-lifting (maximum load) capacity of a BTH device may be exceeded. In such situations, the BTH device could experience a component failure or fatigue more than expected (thereby shortening or ending its service life), and an inspection of the BTH device may be warranted. Without monitoring or tracking, such loading may occur and/or such inspection may not occur unnoticed. Also, users of BTH devices who rely on calculating an expected amount of lifts during service rather than counting actual amount of lifts may take a BTH device out of service earlier than it needs to be or may leave the BTH device in service beyond its approved service life. Further, users may not accurately track due dates for ASME mandated periodic inspection (e.g., monthly, yearly) of particular BTH devices. Managing data related to lift limits and inspections is more complicated in larger facilities, perhaps more so in organizations with multiple locations, where many BTH devices are in use.

In view of the above, a lifting device, system, and method of use that addresses one or more drawbacks of existing devices, systems and methods, or one or more other issues, would be welcome.

### SUMMARY

Aspects and advantages of the disclosed subject matter will be set forth in part in the following description, or may be obvious from the description, or may be learned through practice of the disclosed subject matter. In some aspects, the disclosed subject matter includes a smart lifting device, a system, and a related and method for evaluating a duty cycle status of a lifting device suspendable from a support for lifting loads.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a diagrammatic view of a simple lifting device according to the present disclosure arranged beneath a support fixed to a building structure.

FIG. 2 is a diagrammatic view of a simple lifting device according to the present disclosure arranged beneath a movable support.

FIG. 3 is a front view of one embodiment of a simple lifting device according to the present disclosure.

FIG. 4 is a side view of the lifting device of FIG. 3.

FIG. 5 is an isometric view of the lifting device of FIG. 3.

FIG. 6 is a front view of a lift monitor suitable for use with the device of FIG. 3.

FIG. 7 is a top view of the lift monitor of FIG. 6.

FIG. 8 is an isometric view of the lift monitor of FIG. 6.

FIG. 9 is a schematic view of the lifting device of FIG. 3 as used within a system.

FIGS. 10A and 10B are a schematic views of alternate lifting device embodiments using clevis pin type load cells.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

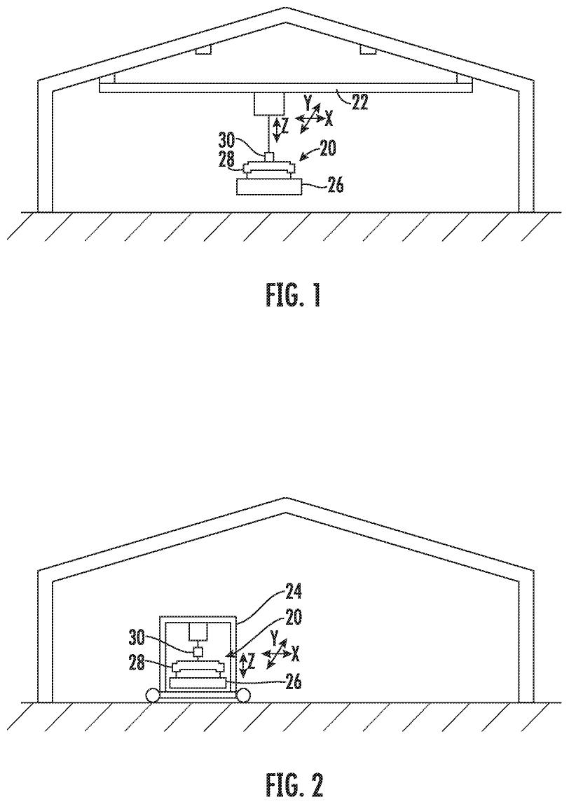

Generally speaking, the present disclosure is directed to lifting devices for lifting loads, wherein data regarding the lifting can be monitored and gathered. FIGS. 1 and 2 show generically a lifting device 20 according to the disclosure suspendable from a support 22 or 24 for lifting loads 26. As shown, support 22 may be fixed to a structure such as a building interior (floor, walls, and/or ceilings), and may therefore be a bridge crane, lift, jib crane, come-along, or other type of BTH lifting device. The support 22 may include various conventional elements that need not be illustrated here, such as a hook, cable, winch or the like for attachment to the lifting device 20 for lifting it (vertically) along with any load 26 that might be attached thereto. Support 22 may also include conventional structures for moving the lifting device horizontally, for example to move the load from one place to another within the structure in which support 22 is located. Support 22 may thus be located without limitation within any suitable enclosed building or indoor/outdoor structure, a manufacturing facility, logistic center, laboratory, material handling facility, maintenance facility, construction site, warehouse, etc. Support 24 may be a structure movable along a floor such as a movable crane, lift vehicle, forklift, etc. Either type of support (22 or 24) is useful for lifting items without limitation, such as inventory, assembly items, maintenance items, vehicle components, etc. Thus, no limitation should be given to the types of fixed or movable supports to which lifting device may be attached and used, or to the types of loads to be lifted.

As illustrated, lifting device 20 includes a base member 28 and a lift monitor 30 attached to the base member and suspendable from the support 22,24. One or more sensors, discussed below, are associated with lifting device 20 so as to obtain data regarding loads being lifted. The sensor, lift monitor 30, and base member 28 are configured so that the mass of the base member and the mass of the load 26 act upon and are supported by the sensor(s) during lifting. In other words, the sensor(s) are exposed to and carry forces of load 26 and base member 28 during a lift.

The sensor(s) determine parameters related to lifting of load 26. As will be discussed below, parameters related to lifting sensed by the at least one sensor may include one or more of an instance of lifting, a force generated during an instance of lifting, and/or an acceleration generated during an instance of lifting.

Lifting device 20 further includes a reporting system for providing information related to the determined parameters. The reporting system may include elements located within or attached to lift monitor 30 and/or base member 28, as well as remotely located elements, and may include one or more of wired or wireless communications devices, display devices, input-output devices, computers, microprocessors, memory, software, variable and fixed databases and lookup tables, etc.

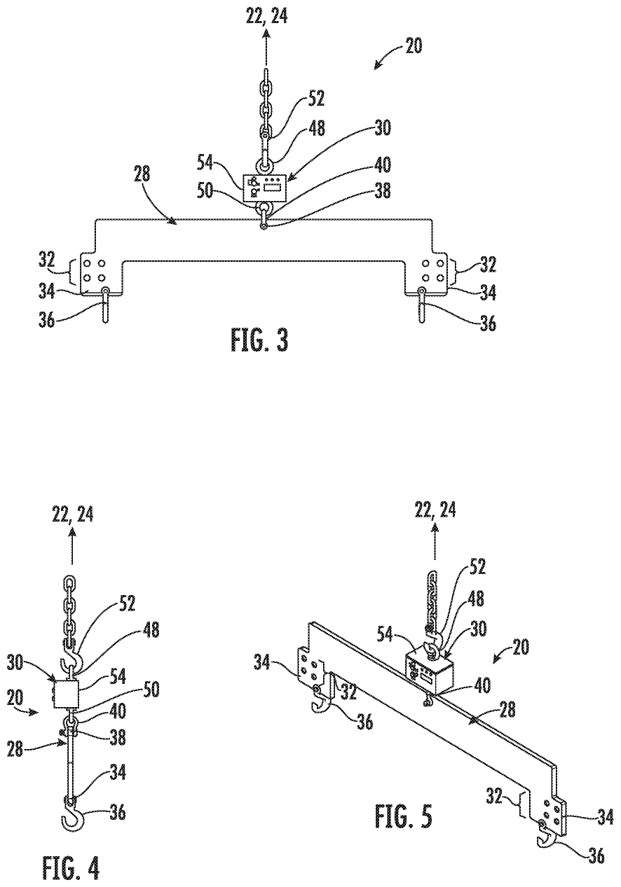

Base member 28 may be a one-piece or multi-piece beam or the like suitable for lifting loads of a desired mass. Base member 28 may thus be made from one or more pieces of a metal such as a steel alloy or an aluminum alloy, may be assembled using fasteners, and/or may include welds, etc. As illustrated in FIG. 3, base member 28 is a spreader beam formed of a single plate of a metal, with openings 32 which may be at ends 34 of base member 28 provided for attachment of hooks 36, or loops, bolts, connectors, etc., depending on the desired application. As illustrated, hooks 36 are fixed at the ends for lifting load 26. Base member 28 and hooks 36 should be selected so as to be rated sufficiently for the desired lifting application (mass, acceleration, duty cycle, etc.), in particular in view of the fatigue caused by lift count during use. However, lifting beams can take many other shapes and configurations depending on application and particularly size of load. Larger and heavier loads call for correspondingly larger beams, base members, etc., which may include multiple parallel or perpendicular plates, flanges, welds, bolts, and the like. Accordingly, no limitation on the type or complexity of base member is intended herein, and the use of the terms base member or lifting beam herein refer collectively to all such items.

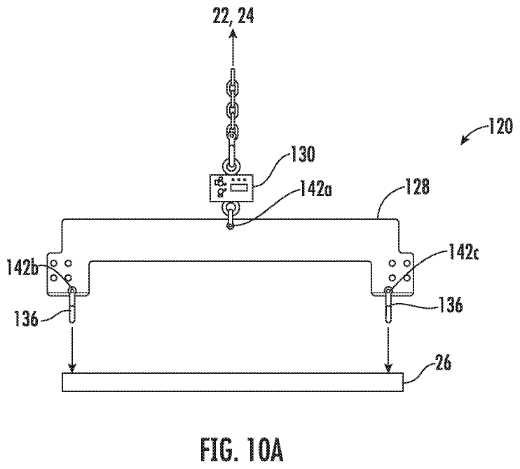

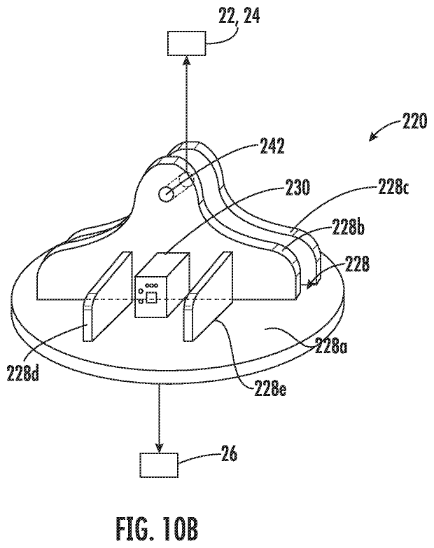

Base member 28 may also include one or more openings 38 for receiving a connector for attachment to an element of lift monitor 30 with internal or external sensor(s). Opening 38 may be centrally located and the connector may be a shackle 40, as illustrated. Alternately (not shown), the connector may be part of lift monitor 30. In another alternative (not shown), multiple openings 38 could be employed for attachment to a flexible structure such as a chain or cable or to a rigid structure for lifting base member 38 from above, with lift monitor 30 located between such flexible or rigid structure and the support so as to be exposed to lifting forces. As another alternative (see FIG. 10B discussed below), lift monitor 30 may be rigidly fixed to base member (rather than attached by hooks, loops or the like), as long as lift monitor and/or the sensor(s) are exposed to such forces.

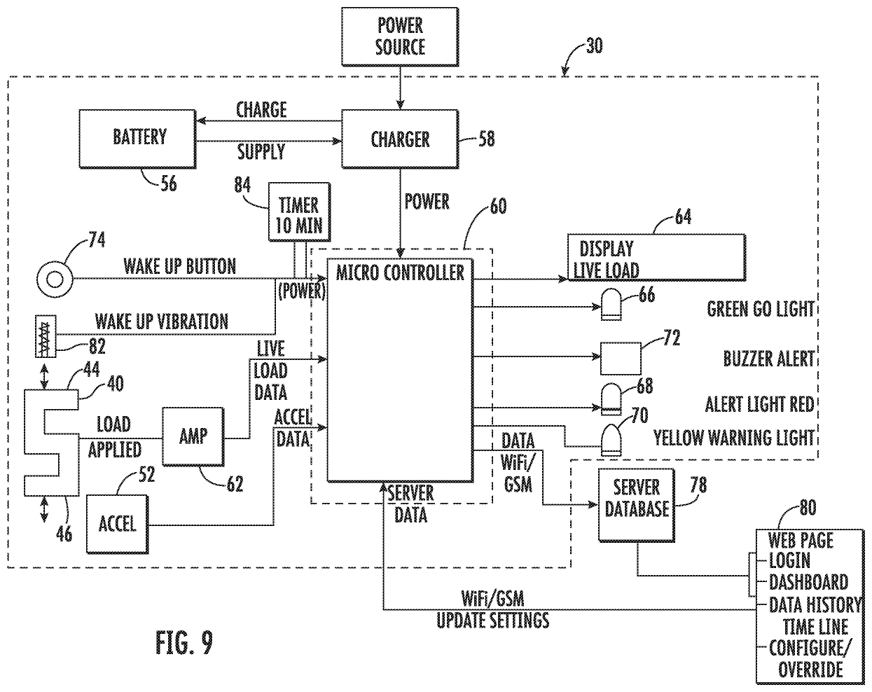

As noted, device 20 includes at least one sensor associated with lift monitor 30 for determining a parameter of lifting of a load. If desired, such sensor may be inside of or attached to lift monitor 30, and may include a load cell for determining a force load (in tension) seen by base member 28. As illustrated in FIGS. 3-9, load cell 42 is a conventional S-shaped load cell made of a steel alloy and having electronic sensors such as strain gauges that output information indicative of the loading on the load cell. Threaded openings at top 44 and bottom 46 of load cell 42 provide attachment to threaded eyebolts 48 and 50. Upper eyebolt 48 can attach to a hook 52, shackle or other structure attached to support 22,24, and lower eyebolt 50 can be attached to beam member, for example by shackle 40. If shackle 40 and eyebolt 50 are somewhat permanently fixed together (e.g., are threaded, require tools to disassemble, etc.), base member 28 and lift monitor 30 will be more readily kept together (as desired), so that information regarding the lifting history of base member 28 will be captured by connected lift monitor 30. If lift monitor 30 and base member 28 are too readily separable, it is possible such information could be inadvertently lost. It would possible to include wireless communication capabilities (RFID, WiFi, cellular, GSM, Bluetooth, GPS, or others) on each of base member 28 and lift monitor 30 to ensure they are kept together and/or that lift monitor obtained data is attributed to the correct base member if lift monitor is used with multiple base members over time. Although load cell 42 is illustrated an a s-shaped, strain gauge based device held within lift monitor 30, load cell 42 could be outside of lift monitor, and other types of load cells or force measurement devices (such as clevis pin type devices as in FIGS. 10A and 10B or others) could be employed to determine the force passing through the base member 28.

The at least one sensor may also include an accelerometer 52 for measuring a vertical acceleration at lift monitor 30. Vertical acceleration may, if desired, be taken into account in evaluating whether a lift meets certain predetermined force parameters apart from those simply generated by mass and gravitational force. For example, forces generated by vertical acceleration may be entirely discounted, may be clipped and therefore discounted if not above a certain range or lasting beyond a certain time duration, and may thus be partially or wholly subtracted from the force measured and reported by load cell 42. Also, two parameters may be noted: force measured and reported by load cell 42 and such force modified in view of accelerometer readings.

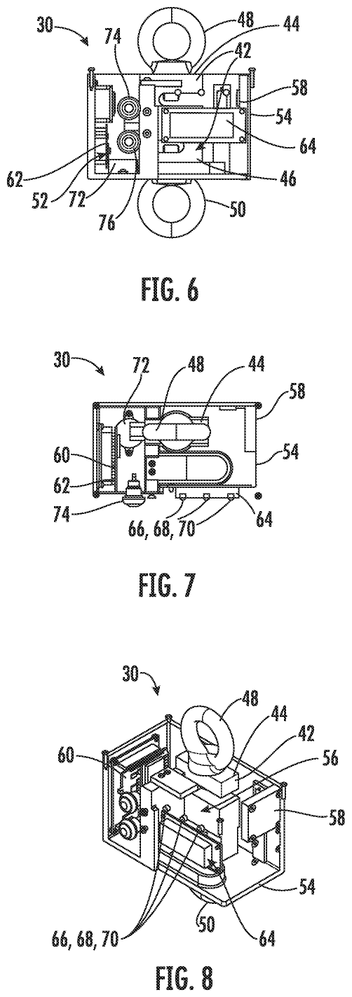

Before discussing operation of lifting device and a system utilizing it, other elements of lifting device should be noted. For example, lift monitor 30 also includes a housing 54 holding and protecting such sensor elements 42, 52. Also within housing is a power source, such as a battery 56, and if desired onboard battery charger circuitry 58. Alternatively, a plug for connection to external charger could be provided, solar charging, wireless charging, etc. could be employed to charge battery 56. Alternatively, battery 56 could be avoided and power could be provided via an electrical cable to lift monitor, or any combination of AC or DC power could be employed, as desired. (Note that for simplicity and clarity in the drawings conventional electrical connections between elements such as load cell 42, battery 56, etc., and some walls of housing 54 are not illustrated in FIGS. 6-8).

A printed circuit board (PCB) 60 is mounted within housing 54 and holds electronics such as a microcontroller having a processor and a memory storing code for operating lift monitor 30 and its components such as its sensors, input output devices, wired or wireless (WiFi/cellular/GSM/Bluetooth/RFID/GPS) communications devices, etc. An amplifier 62 may be electrically connected to an output of load cell 42 and mounted on or adjacent PCB 60 for receiving and amplifying the signal from load cell 42 so as to be usable by microcontroller and lifting device 20 in general.

Display 64 may be attached to housing 54 to provide a user alphanumeric or pictographic information regarding the status of lift monitor 30 and/or base member 28. One or more dedicated indicators such as LED's 66,68,70 may also be provided to give a user information. Such indicators may be of different colors (e.g., green, yellow, red) or may be illuminated, flash, in different patterns, etc., to indicate different things to the user, as desired. An audible signaling device 72 such as a buzzer, vibrator, speaker, etc. may also be provided to give the user feedback as to status of lift monitor 30 and base member 28. One or more i/o elements 74,76 such as buttons, switches, keypads or the like may be employed on housing 54 to allow a user to turn lift monitor on or off, or to select and vary different device settings, clear onboard memory, rest or reset device, communicate with a remote computer or other device within system, etc. As an alternative to an off/on button or the like, housing may also use accelerometer 52 or a vibration sensor 82 to “wake up” lift monitor. If desired, the microcontroller on PCB 60 may include a clock function 84 to shut down or “sleep” onboard electronics if no motion and/or i/o element function is sensed after a given period of time.

Thus, display 64, indicators 66,68,70, signaling device 72 are part of a reporting system for providing a user information regarding the status of the lifting device, a current lift, a history of lifts (whether within or outside of desired protocols), etc. However, such reporting system may also or alternatively include elements spaced from lift monitor 30 and base member 28. For example, a first computer 78 may be in communication with lift monitor 30 via wired or wireless communication (WiFi, cellular, GSM, Bluetooth, RFID, GPS, etc.). First computer 78 may be a general purpose computer such as a workstation, laptop, or the like, a dedicated computer, a smart phone or other device, either at or near a location in which lift monitor is located, or at a remote location. First computer 78 may also be a local or remote server that maintains a database of information regarding one or more lift monitors and base members. Second computer 80 may also include a general purpose computer such as a workstation, laptop, or the like, a dedicated computer, a smart phone or other device, housing dedicated software and/or providing an internet connection so as to, via wired or wireless connection, monitor and manipulate data in the database, configure a system including one or more lift monitors and base members, provide periodic or live status reporting, to provide error, overload, or inspection reporting, etc. If desired, first and second computers can be the housed at the same or different locations, and the functions of first and second computers can be met by a single computing device. In applications and systems where multiple base members are in use, first computer and/or second computer can be employed to manage all such base members via their related lift monitors.

Thus, in use a memory on PCB 60 and/or within first or second computers 78,80 may increment and store a lift count based on the detected instance of lifting, as sensed by the at least one sensor (load cell 42 with or without input from accelerometer 52). Such memory may store a predetermined lift count limit, and the reporting system (indicators, first and second computers) indicates when the lift count reaches the predetermined lift count limit. The predetermined lift count limit may for example indicates need for at least one of inspection of the lifting device, maintenance of the lifting device, and retirement of the lifting device.

Depending on the application, and the characteristics of the base member such as from which what alloy of which metal it is made, the incrementing may be different. For example, for aluminum, all lifts may require incrementing, whereas for steel, only lifts above a minimum force amount may require incrementing. Such information can be stored in the computer 78/80 database and/or stored onboard on the memory within the lift monitor 30. Thus, where the sensor includes load cell 42 for detecting a force generated at the lift monitor during an instance of lifting, and the memory stores the detected force, the memory may also store a predetermined force limit, with the reporting system indicates when the detected force reaches the predetermined force limit stored in the memory. The lift count may only be incremented when the detected force reaches the predetermined force limit stored in the memory to avoid counting lifts that do not fatigue base member 28. By avoiding counting all lifts, unnecessary inspection and/or unnecessarily early retirement of base member 28 may be avoided. Again, such force may be calculated with or without factoring in input from accelerometer 52. By utilizing accelerometer 52, certain lifts that appear to exceed rated limits may be determined to be within limits, either maximums (safety limits) or minimums (sufficient for incrementing). Thus, if some “within-safe-limits” lifts can be excluded in spite of nominal load cell readings, then useful life of the base member can be extended and unnecessary inspections can be avoided. Regardless, by using the load cell (and possibly also the accelerometer) and transmitting the detected information to an onboard or remote memory along with base member identification/location information, a robust and detailed history of use of base member 28 is made possible that previous devices could not provide.

FIG. 10A shows a modified device 120 substantially similar to device 20 above, but in which the load sensor(s) are not held within lift monitor 130. In such case a single clevis pin type load sensor could be employed in a location subject to full force during lifting, for example as shown as pin 142a between base member 128 and lift monitor 130. Alternatively, a design with one clevis pin type load cell as the sensor could also be employed at a location above lift monitor where it connects to the chain, cable, etc. extending to the support to which device 120 is attached, or at a location below base member (between base member and the load being lifted), in either case as long as the single sensor is subject to full load during lifting.

If desired, multiple clevis pin type load cells could be employed at locations that provide an additive total load between overhead structures and load. Thus, pins 142b and 142c, respectively attached to hooks 136 or other structure beneath ends of base member to which load is attached, may include clevis pin type load cells. Total loading experienced at pins 142b and 142c could be measured and used as noted above.

One or more clevis pin type load cells (not shown) could also be employed within lift monitor 130 with above and below connections modified accordingly so that total loading is obtained. Alternatively multiple load cells could be attached in a way that more than one are subject to full load, and the loading noted is compared, averaged, etc.

FIG. 10B shows another alternative device 220 which may be of a more heavy duty construction. Device 220 includes a base member 228 including a round plate 228a, two upright plates 228b and 228c, and four support flanges (two visible being 228d and 228e). Such base members 228 may be employed to lift objects on the order of tens of tons. Lift monitor 230 is fixedly attached to base member 228. Lift cell 242 is a clevis pin type sensor extending through holes in plates 228b and 228c. A cable chain or the like may be attached to load cell 242 between the plates to suspend device 220 and load 26 from support 22/24.

Depending on the location of the load cell(s), communication connection to lift monitor may be wired or wireless. If wireless a separate power and communication system for the load cell(s) may be required and a receiver function may be required for the lift monitor, along the lines discussed above.

The lifting devices of the present disclosure can be used to perform various methods, including a method for evaluating a duty cycle status of a lifting device suspendable from a support for lifting loads, the method comprising the steps of: attaching a load 26 to a base member 28/128/228; lifting the base member and the load using the support 22,24; monitoring parameters related to the lifting step using a lift monitor 30/130/230 attached to the base member 28, and having at least one sensor 42, the at least one sensor detecting at least an instance of lifting; and reporting information related to the determined parameters.

The method can include other options such as incrementing and storing a lift count based on the detected instance of lifting, and/or indicating when the lift count reaches a lift count limit. The sensor may detect a force generated during an instance of lifting, and the device may only then indicate when the detected force reaches a predetermined force limit. The predetermined force limit is dependent in part on a characteristic of the base member, and the characteristic may be a material of the base member. The lift count may be incremented only when the detected force reaches the predetermined force limit.

The at least one sensor may detect an acceleration generated during an instance of lifting. The device may then calculate using the detected force and the detected acceleration whether the predetermined force limit has been reached. For example, forces cause by movement/acceleration (not gravity) may be excluded from the determination by subtracting same from the output of the load cell. The lift count may be incremented by an increment amount only if calculating step determines that the detected force has reached the predetermined force limit.

In the methods of use, a duty cycle lift limit is assigned to the base member, the duty cycle lift limit being recalculated in view a difference of a number of instances of lifting and the increment amount. The duty cycle lift limit may be assigned to the base member, the duty cycle lift limit being recalculated (either by adjusting upward the lift limit or by excluding certain lifts to calculate a lower qualifying lift total—the result is the same in terms of remaining lift lifespan) in view a cumulative amount of force of all instances of lifting.

The method may include displaying on a display the information related to the determined parameters, and the display may be attached to the lift monitor, or on a station located remotely from the lift monitor, the method further including wirelessly communicating the information related to the determined parameters to be displayed on the display. In a larger system at one or more locations, a plurality of the base members may be employed each having a respective lift monitor in wireless communication with the station. Each of the lift monitors may communicate an identity via the communications system so that the computer can centrally monitor the parameters related to lifting of the load for each of the base members.

The disclosed device and methods thus provide multiple separately or collectively useful benefits and functions. The lift monitor may be retrofitted onto existing devices or used with new base members. Base members can be accurately tracked, warnings and notices can be provided, and the useful life of a lift member can be optimized using the collected and evaluated information. By incorporating acceleration information, more accurate information about loads lifted can be obtained. Minimum lift forces suitable for incrementing and maximums suitable for safety warnings can be noted and logged. A database of maximum lift weights, dates and times, and lift member identity can be reliably tracked, all remotely if desired. Large populations of lift members can be tracked and monitored so as to achieve certainty and efficiency, all using one or more aspects of the above devices and methods.

It should be appreciated by those skilled in the art that various modifications and variations can be made in the present disclosure without departing from the scope and spirit of the disclosure. It is intended that the present disclosure include such modifications and variations as come within the scope of the appended claims and their equivalents.

1. A lifting device suspendable from a support for lifting loads, the lifting device comprising:
a base member, the load being suspendable from the base member;
a lift monitor attached to the base member;
at least one sensor associated with the lift monitor for detecting at least an instance of lifting and generating a responsive signal to the lift monitor, the lift monitor then determining parameters related to lifting of the load;
the at least one sensor, the lift monitor, and the base member being configured so as to support a mass of the base member and a mass of the load during lifting, and so as to expose the at least one sensor to at least the mass of the load; and
a reporting system for providing information related to the determined parameters.

2. The lifting device of claim 1, further including a memory, the memory incrementing and storing a lift count based on the detected instance of lifting.

3. The lifting device of claim 2, wherein the memory is located in the lift monitor.

4. The lifting device of claim 2, wherein the memory stores a predetermined lift count limit, and the reporting system indicates when the lift count reaches the predetermined lift count limit.

5. The lifting device of claim 4, wherein the predetermined lift count limit indicates need for at least one of inspection of the lifting device, maintenance of the lifting device, and retirement of the lifting device.

6. The lifting device of claim 1, wherein the at least one sensor includes a load cell for detecting a force generated during an instance of lifting.

7. The lifting device of claim 6, further including a memory, the memory storing the detected force.

8. The lifting device of claim 7, wherein the memory stores a predetermined force limit, and the reporting system indicates when the detected force reaches the predetermined force limit stored in the memory.

9. The lifting device of claim 8, wherein the memory stores a characteristic of the base member, the predetermined force limit being dependent in part on the characteristic of the base member.

10. (canceled)

11. (canceled)

12. The lifting device of claim 7, wherein the at least one sensor includes an accelerometer for detecting an acceleration at the lift monitor during an instance of lifting.

13. The lifting device of claim 12, wherein the memory stores the detected acceleration.

14. The lifting device of claim 13, wherein the lift monitor includes a microcontroller, the microcontroller calculating using the detected force and the detected acceleration whether the predetermined force limit has been reached.

15. The lifting device of claim 14, wherein the lift count is incremented only when the detected force calculated by the microcontroller reaches the predetermined force limit.

16. The lifting device of claim 1, wherein the lift monitor includes a housing permanently attached to the base member.

17. The lifting device of claim 1, wherein the reporting system includes a display for displaying the information related to the determined parameters.

18. (canceled)

19. The lifting device of claim 17, wherein the display is also located on a station located remotely from the lift monitor, the lift monitor including a communications device for communicating the information related to the determined parameters to be displayed on the display.

20. The lifting device of claim 19, wherein the communications device is a wireless communications device.

21. The lifting device of claim 20, wherein the reporting system includes a computer associated with the display and located remotely from and in wireless communication with the communications device.

22. A system including a plurality of the lifting devices of claim 21, each of the lifting devices being in wireless communication with the computer.

23. The system of claim 22, wherein each of the lifting devices communicates an identity via the communications system so that the computer can centrally monitor the parameters related to lifting of the load for each of the lifting devices.

24. The system of claim 23, wherein each of the lifting devices communicates a location of the respective lifting device via the communications system.

25-29. (canceled)

30. The lifting device of claim 1, wherein the base member is a lifting beam.

31. The lifting device of claim 1, wherein the at least one sensor is a load cell which is a component of the lift monitor.

32. The lifting device of claim 1, wherein the at least one sensor is a load cell which is spaced from the lift monitor.

33. (canceled)

34. The lifting device of claim 32, wherein the load cell is in one of wired or wireless communication with the lift monitor.

35. A method for evaluating a duty cycle status of a lifting device suspendable from a support for lifting loads, the method comprising the steps of:
attaching a load to a base member;
lifting the base member and the load using the support;
monitoring parameters related to the lifting step using at least one sensor subject to the load and a lift monitor attached to the base member, the at least one sensor detecting at least an instance of lifting; and
reporting information related to the determined parameters.

36-54. (canceled)
